(19) United States
(12) Patent Application Publication
(10) Pub. No.: US 2026/0248084 A1
(43) Pub. Date: Aug. 27, 2026

(54) System and method for plant production

(71) Applicant: Peter Fox, Sydney (AU)

(72) Inventor: Peter Fox, Sydney (AU)

(21) Appl. No.: 19/167,277

(22) PCT Filed: Dec. 20, 2023
(86) PCT No.: PCT/AU2023/051336

§ 371 Date: Sep. 19, 2025

(30) Foreign Application Priority Data
Dec. 21, 2022 (AU) 2022903933

(51) Int. Cl. A01G 31/00

(52) U.S. Cl. CPC A01G 31/008

(57) ABSTRACT

There is provided an integrated farming system comprising a primary hydroponic component for growing plants; a plurality of point-of-use hydroponic components to maintain optimum nutrient density of the plants wherein the point-of-use hydroponic components are in proximity to the primary component; and a monitoring device configured to determine the measurement of at least one monitored parameter of the plants in the point-of-use hydroponic components and communicate the measurement of at least one monitored parameter to the primary hydroponic component.

### TECHNICAL FIELD

The technology relates to integrated hydroponic systems for the propagation and distribution of plants, and maintenance of the plants at a point-of-use. In particular, the system maintains the plants with optimal nutrient density compared to soil grown plants or plants shipped to the point-of-use.

### CROSS REFERENCE TO RELATED APPLICATION

This application claims priority to Australian provisional patent application number 2022903933, filed on 21 Dec. 2022, and which is incorporated by reference in its entirety.

### BACKGROUND

Traditional farming operations are usually located in agricultural areas, which require significant capital expenditure, large areas of land dedicated to growing a small number of crops and have high operational costs from seed to sale.

Conventional urban and local agriculture is also problematic. Growing space in urban areas is limited and there is a high start-up and operating cost for structures such as greenhouses. Structures for rooftop farming require considerable engineering to support the weight of a rooftop farm. Urban gardens may also need to address contaminated soil and air pollution.

Typical hydroponics systems are not easily used in urban locations as most hydroponic systems are designed for installation in agricultural settings, are not easily transportable, and require skilled training of personnel for operation.

Farming systems have been developed to address these issues. For example, hydroponic facilities and ‘local farms’ are commonly used. However, these systems utilise traditional supply chains to distribute plants that are grown in a central facility, harvested, stored and shipped to a market, purchased wholesale and then shipped to a consumer either directly or for purchase at a supermarket. That is, existing solutions utilise the current food supply model which is based on long distance shipping, and extended storage periods. This food supply model is economically and environmentally unsustainable.

Threats to food security are increasing due to climate change, supply chain challenges, air and soil contamination and acceptable yield. Additionally, the need for fresh, nutrient dense food is growing due to an increasing population and as climate change changes impacts conventional soil based agriculture.

The present inventor has developed an integrated hydroponic grow system to grow and deliver fresh, nutrient dense plants that are maintained at the point-of-use.

### SUMMARY

In a first aspect, there is provided an integrated farming system comprising:
a) a primary hydroponic component for growing plants;
b) a plurality of point-of-use hydroponic components to maintain optimum nutrient density of the plants wherein the point-of-use hydroponic components are in proximity to the primary component; and
c) a monitoring device configured to measure at least one parameter of the plants in the point-of-use hydroponic components and communicate the measurement of at least one monitored parameter to the primary hydroponic component.

In one embodiment the measurement of at least one monitored parameter is selected from a number of plants in the point-of-use hydroponic components (with the monitored parameters include; plant density, plant condition, plant air temperature, relative humidity, light intensity, air velocity, air circulation, and duration of time spent in the point-of-use hydroponic component), with the measurement (or measurements) being then communicated to the primary hydroponic component. Preferably the relevant measurement used for this purpose is either the monitored parameter in respect of plant density or duration of time spent in the point-of-use hydroponic component.

In a second aspect there is provided a method of growing and distributing plants, the method comprising:
a) growing a plurality of plants in a primary hydroponic component;
b) transferring the plants from the primary hydroponic component to a plurality of point-of-use hydroponic components to maintain optimum nutrient density of the plants and wherein the point-of-use hydroponic components are in proximity to the primary component;
c) monitoring at least one parameter of the plants in the point-of-use hydroponic component; and communicating the measurement of at least one monitored parameter to the primary hydroponic component; and
d) adjusting the plants in the point-of-use hydroponic components in response to the measurement of at least one monitored parameter.

In one embodiment the measurement of at least one monitored parameter is selected from a number of plants in the point-of-use hydroponic components (with the monitored parameters including; plant density, plant condition, plant air temperature, relative humidity, light intensity, air velocity, air circulation, and duration of time spent in the point-of-use hydroponic component), with the measurement (or measurements) being then communicated to the primary hydroponic component. Preferably the relevant measurement used for this purpose is either the monitored parameter in respect of plant density or duration of time spent in the point-of-use hydroponic component.

The adjusting may involve removing plants in poor condition and/or replenishing plants that have been removed from a point-of-use hydroponic component.

In one embodiment the proximity of the point-of-use hydroponic component to the primary component is less than five kilometres, preferably less than three kilometres, even more preferably less than two kilometres.

Preferably the replenishing does not involve an outbound supply chain from the primary component, even more preferably the replenishing doe not use of a vehicle.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this specification.

In order that the present invention may be more clearly understood, various embodiments will be described with reference to the following drawings and examples.

### DESCRIPTION

The technology relates to systems and methods for the hydroponic production or plants and maintenance of the plants at point-of-use.

In one aspect there is provided an integrated farming system comprising a primary (or macro) hydroponic system to propagate plants. The system also comprises a plurality of point-of-use (or micro) hydroponic components to receive plants from the primary component and maintain optimum nutrient density of the plants. The micro components also comprise a monitoring device configured to monitor at least one parameter of the plants in the point-of-use hydroponic components and communicate the measurement of the monitored parameter (or monitored parameters) to the primary hydroponic component. The point-of-use hydroponic components are in proximity to the primary component.

The primary (or macro) hydroponic component can be any conventional hydroponic system. In one embodiment the primary (or macro) component comprises at least one grow tray or channel adapted to receive one or more grow units. Each grow unit is a porous receptacle containing growth media for propagation of a plant. The component comprises a reservoir containing a nutrient solution a pump in fluid communication with the nutrient solution in the reservoir and one or more conduits in fluid communication with the pump for supplying the nutrient solutions to plants in each grow unit. The grow tray or channel further comprises a return in fluid communication with the reservoir. The return allows the nutrient solution to flow from the grow tray or channel back to the reservoir for recirculation.

In some embodiments the primary (or macro) hydroponic component comprises multiple grow trays or channels are connected to a single reservoir and may be stacked, for example each grow tray or channel can be stacked in shelving unit or similar. Accordingly, by varying the length of the grow trays or channels and the number in a stack the primary component can quickly be adapted to fit available space.

The component further comprises a lighting means. The lighting means provides the plants with light of the appropriate wavelengths and intensity to support optimal growth rates and nutrient density. It is envisaged that any lighting means can be used. Example of suitable lighting means include those that comprise one or more of fluorescent tubes, compact fluorescent lights, high-intensity discharge (HID) lights, metal halide, high-pressure sodium (HPS) and light emitting diodes (LEDs). Preferably the lights are LEDs.

In some embodiments the component has a lighting controller that controls one or more of the intensity, duration, wavelength, and periodisation.

In some embodiments the primary component can be adapted to be used in underutilised commercial real estate, for example in basements or storage areas.

The grow units can comprise any container suitable for holding a growth medium and growing plants for example pots or growbags. The grow units are porous, in this context porous means permeable to fluids. For example the grow unit can be a fabric pot or grow bag in which the material itself is porous or the grow unit may be a plastic pot having drainage holes in which case the material is non-porous but the drainage holes prove the porosity.

In one embodiment the grow unit is a pot, for example a rectangular shaped container with an open top and a plurality of drainage holes.

The grow unit is adapted to retain a growth medium. Any suitable growth medium known in the art can be used. In some embodiments the growth medium is inert. Examples of suitable inert growth media that comprise or consist of perlite, vermiculite, rockwool, clay pebbles or any combination thereof.

In some embodiments the growth media does not include an organic component.

In other embodiments the growth medium may additionally or alternatively comprise an organic component. Suitable organic components include coco fibre, potting mix, potting soil, soil, peat or any combination thereof.

In use the reservoir contains a volume of liquid nutrient solution. A skilled person will be able to select an appropriate nutrient solution by taking in to account the type of plants being grown, the growth media used an the environmental conditions in which the primary component and point-of-use components are operating. Liquid

A typical base nutrient mix may include 14% total nitrogen (for example as nitrate), 17% calcium, 0.015% Boron, 0.01% chelated copper, 0.07% chelated iron, 0.025% chelated manganese, 0.002% molybdenum, and 0.01% zinc. This mix can be dissolved in water to the desired concentration.

The base mix can be supplemented with various additional nutrients for specific types of growth, for example to support vegetative growth and additional mix of 2% total nitrogen (for example as nitrate), 8% phosphate, 3% magnesium, 8% combined sulfur and 0.01% chelated iron can be used. This mix can be added to the base mix solution.

A typical nutrient solution to support blooming (flowering) can include 12% phosphate (e.g. P₂O₅), 24% potash (K₂O), 3% magnesium, 9% combined sulphur and 0.01% chelated iron can be used. This mix can be added to the base mix solution. In some embodiments, for example when growing flowering plants the nutrient mix can be supplemented to enhance flower quality. Suitable supplements include calcium, boron, copper, iron, manganese, molybdenum and zinc. These can be derived from, for example calcium chloride, Iron EDTA, Iron DTPA, Iron EDDHA, Zinc EDTA, Manganese EDTA, Sodium Molybdate, Boric Acid, Copper EDTA, and chelated zinc, respectively.

The reservoir can be any container suitable for retaining a suitable volume of liquid and which can be plumbed into the growth trays or channels. The reservoir is fitted with conduits to direct the flow of the nutrients solution to the plants. This can be achieved in a number of ways, for example the nutrient solution can be fed into the growth channels or trays such that the plants sit in the solution, alternatively the nutrient solution can be drip fed or sprayed onto the plants of growth medium and drain into the grow tray or channel.

The grow tray or channel has a return outlet through which the nutrient solution is returned to the reservoir via a conduit.

The reservoir may optionally be fitted with an aeration device. Alternatively or in addition the reservoir may be fitted with a heating and/or cooling device.

In one embodiment the component comprises a pump for pumping the nutrient solution to the plants. The nutrient solution may be continuously pumped to the plants or may be intermittently pumped. In other embodiments the reservoir may be located above the plants and the nutrient solution is gravity fed to the plants, in a continuous or intermittent manner before being pumped back to the reservoir.

The system comprises a plurality of point-of-use hydroponic components to maintain optimum nutrient density of the plants.

Each point-of-use hydroponic components is a self contained hydroponic component comprising a housing for a frame. The housing is designed for aesthetics and to hold a frame. The frame holds one of more grow channels or trays, a reservoir in fluid communication with the grow channels, a pump and a lighting device. The grow channels or trays are adapted to hold a plurality of grow units (in which plants are grown) and receive a nutrient solution from a reservoir. Like the primary component the nutrient solution can be received into the trays or tubes or it can be applied to the plants or growth media n the grow units.

Each point-of-use hydroponic component is located at or near the point at which the plants will be used. For example, the point-of-use hydroponic components can be located in commercial kitchens, corporate offices, educational institutions, supermarkets, grocery stories and the like. In this context, point-of-use refers to either the use of the plant (i.e. consumption or use in the preparation of a meal) or point of sale to a consumer.

The point-of-use components are located in physical proximity to the primary component, for example at a nearby location. For example, in some embodiments the primary component may be located in an underutilised commercial premises, such as a basement or unused portion of an office building. The point-of-use components may be located in nearby retail precents, office foyers, restaurants, kitchens, or cafes. The physical proximity of the primary and point-of-use components facilitates rapid replenishing of each point-of-use hydroponic components from the primary component and eliminates the outbound supply chain and associated costs (e.g. warehousing, storage management, distribution channels, and coordinating operations). That is, the integrated system allows the provision of plants to a customer, in the right quantity, in the right condition, at the right place, and the right time.

By combining the primary and point-of-use components in physical proximity the system maintains the plants with optimal nutrient density compared to soil grown plants or plants shipped to a point of sale.

The systems maintain nutrient density of the plants in the point-of-use components in multiple ways including the following:
a. avoiding the need for long distance (>10 km) transport; and
b. avoiding the need for storage of the plants before arrival at the point-of-use component

The integrated system has another advantage in that it is substantiable. That is the integrated system provides capacity to maintain or improve the state and availability of nutrient dense plants over the long term. This can be achieved as the primary component is typically located in underutilised real estate that is otherwise unsuitable for farming, for example basements, car parks, and office buildings and as the point if use components are in proximity to the primary component an outbound supply chain is eliminated.

The integrated system also provides a quantifiable environmental, social, and governance (ESG) benefit. ESG refers to a set of criteria for an organisation's ability to create and sustain long-term value. Environmental criteria consider how an organisation safeguards the environment, including for example policies addressing climate change. Social criteria examine how an organisation manages relationships with employees, suppliers, customers, and the communities where it operates. Governance deals with a company's leadership, executive pay, audits, internal controls, and shareholder rights. Provides a quantifiable ESG measure. The integrated system provides a clear demonstration that organisations that house either the primary of point-of-use components meets their environmental and social criteria.

The point-of-use component comprises a monitoring device configured to determine the measurement of at least one monitored parameter of the plants in the point-of-use hydroponic components and communicate the measurement of at least one monitored parameter to the primary hydroponic component.

The monitoring device can be is used to monitor or otherwise observe the plants in the point-of use component. Information sufficient to determine the measurement of at least one monitored parameter of the plants is collected by the monitoring device. The measurement of at least one monitored parameter may be selected from number of plants in the point-of-use hydroponic components (with the monitored parameters including; plant density, plant condition, plant air temperature, relative humidity, light intensity, air velocity, air circulation, and duration of time spent in the point-of-use hydroponic component). The component can monitor or otherwise observe, and therefore determine the measurement of one or more of these monitored parameters or any combination of the monitored parameters.

The monitoring device is adapted to associate with or form part of the point-of-use component. The monitoring device typically includes a housing and within the housing the monitoring device comprises one or more sensors, a power source, a communications unit, and optionally a processor.

In some embodiments the sensors, power source, communications unit, and processor are contained within the housing. In some embodiments, a portion of one or more of the sensors, such as a temperature probe, flow meter, camera lens, moisture sensor, may protrude through the housing.

Suitable sensors include cameras (e.g. to monitor plant condition, and number of plants in the point-of-use component), temperature probes, air flow meters, light meters, and bar code readers. For example grow units can carry a barcode and as these are added to the point-of-use hydroponic components they can be scanned, they can also be scanned and from this information the length of time the grow unit is in the point-of-use hydroponic component can be determined.

Similarly, periodic photography of the point-of-use hydroponic components can be used to determine how many grow units have been removed (and hence require replacement).

As will be understood, any suitable sensor described above can be included in the sensor unit and any combination of those sensors can be used in the sensor unit.

Power can be provided to the sensors and processor using any suitable power source or and all of the sensors and the processor may be coupled to the same power source or some of the sensors (or even all of the sensors) and sensor processor may have individual power sources.

In some embodiments, the sensors and processor are continuously active. In other embodiments, the sensors and processor are active intermittently (for example every 1, 5, 15, 30, 45, or 60 minutes). Optionally, the period may be programmable. In one embodiment the period is altered based on data from one or more of the sensors. In another other embodiment the sensors and processor are activated manually or automatically by the sensor device or display device. In some embodiments the sensors and processor are activated automatically when the sensor device is put into motion.

In some embodiments, each sensor may have different activation schedules (e.g. continuous, intermittent, manual). For example, a temperature sensor may measure temperature periodically, and the camera may be activated automatically when motion is detected (e.g. on removal of the grow unit).

The processor can be any suitable processor and may include, or be coupled to memory for storing data received from the sensors. The processor can be wired or wirelessly coupled to the sensor. In some embodiments, the processor may include analysis algorithms for analysing or partially analysing data received from the sensor. In other embodiments, the processor may be used to receive, store, and transmit data received from the sensors.

The communications unit can be any suitable communications arrangement that can transmit information from the processor or sensors to another device or component (such as a the primary component) The communications unit can transmit this information by any suitable wired or wireless technique such as Bluetooth, near field communications, WiFi, infrared, radio frequency, acoustic, optical, or by a wired connection through a data port in the monitoring device.

Information communicated from the point-of-use component to the primary component can be used to instigate the dispatch of plants from the primary component to replenish the point if use component, for example to replace plants that have been removed from the point-of-use component by a user or to replace plants that have been retained in the point-of-use component for too long.

There is also provided a method of growing and distributing plants. In the method a plurality of plants are grown in the primary hydroponic component and transferred from the primary hydroponic component to the point-of-use hydroponic component to maintain optimum nutrient density of the plants. The point-of-use hydroponic component is in proximity to the primary component.

The method further involves monitoring at least one parameter of the plants in the point-of-use hydroponic components and communicating the measurement of at least one monitored parameter to the primary hydroponic component and adjusting the plants in the point-of-use hydroponic component in response to the measurement of at least one monitored parameter.

The measurement used for the purpose of the abovementioned adjustment may be the monitored parameter in respect of the number of plants in the point-of-use hydroponic components, plant density, plant condition, air temperature, relative humidity, light intensity, air velocity, air circulation, and a duration of time a plant or grow unit has spent in the point-of-use hydroponic component. Preferably the relevant measurement used is either the monitored parameter in respect of plant density or duration of time spent in the point-of-use hydroponic component.

In one embodiment the method provides consumers with plants of optimal nutrient density in the point-of-use component. This involves adjusting the plants in the point-of-use component, for example by removing plants in poor condition and/or replenishing plants that have been removed from a point-of-use hydroponic component.

Preferably the point-of-use components are in close physical proximity to the primary component. For example each point-of-use components may be less than five kilometres, preferably less than three kilometres, even more preferably less than two kilometres from the primary component.

This allows the plants in the point-of-use component to be distributed to a consumer without the need for an outward supply chain, preferable without the need for the use of a vehicle.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An integrated farming system comprising:
a) a primary hydroponic component for growing plants;
b) a plurality of point-of-use hydroponic components to maintain optimum nutrient density of the plants wherein the point-of-use hydroponic components are in physical proximity to the primary component; and
c) a monitoring device configured to measure at least one parameter of the plants in the point-of-use hydroponic components and communicate the at least one parameter to the primary hydroponic component.

2. The system of claim 1, wherein the at least one parameter is selected from number of plants, plant density, plant condition, plant air temperature, relative humidity, light intensity, air velocity, air circulation, and a duration of time spent in the point-of-use hydroponic component, in at least one of the point-of-use hydroponic components.

3. The system of claim 1, wherein the parameter is plant density or duration of time spent in at least one of the point-of-use hydroponic components.

4. A method of growing and distributing plants, the method comprising:
a) growing a plurality of plants in a primary hydroponic component;
b) transferring the plants from the primary hydroponic component to at least one of a plurality of point-of-use hydroponic components to maintain optimum nutrient density of the plants and wherein the point-of-use hydroponic components are in proximity to the primary component;
c) monitoring at least one parameter of the plants in the point-of-use hydroponic component; and communicating the at least one parameter to the primary hydroponic component; and
d) adjusting the plants in the point-of-use hydroponic components in response to the at least one monitored parameter.

5. The method of claim 4, wherein the at least one parameter is selected from number of plants in the point-of-use hydroponic components, plant density, plant condition, plant air temperature, relative humidity, light intensity, air velocity, air circulation, and a duration of time spent in the point-of-use hydroponic component.

6. The method of claim 4, wherein the parameter is plant density or duration of time spent in the point-of-use hydroponic component.

7. The method of claim 4, wherein the adjusting involves removing plants in poor condition and/or replenishing plants that have been removed from a point-of-use hydroponic component.

8. The method of claim 4, wherein the proximity is less than five kilometres, preferably less than three kilometres, even more preferably less than two kilometres.

9. The method of claim 7, wherein the replenishing does not involve the use of a vehicle.
